(19) United States
(12) Patent Application Publication
(10) Pub. No.: US 2013/0238996 A1
(43) Pub. Date: Sep. 12, 2013

(54) CONTROLLING SOUND OF A WEB BROWSER

(71) Applicants: Beijing Kingsoft Internet Security Software Co., Ltd., (US); Conew Network Technology (Beijing) Co., Ltd., (US); Shell Internet (Beijing) Secutity Technology Co. Ltd., (US)

(72) Inventors: Chuanda DING, Beijing (CN); Yu HAN, Beijing (CN); Mingyan SUN, Beijing (CN); Ming XU, Beijing (CN)

(73) Assignees: Beijing Kingsoft Internet Security Software Co., Ltd., Beijing (CN); Shell Internet (Beijing) Secutity Technology Co., Ltd., Beijing (CN); Conew Network Technology (Beijing) Co., Ltd., Beijing (CN)

(21) Appl. No.: 13/786,831

(22) Filed: Mar. 6, 2013

(30) Foreign Application Priority Data
Mar. 8, 2012 (CN) 201210060114.6

(51) Int. Cl. G06F 3/16

(52) U.S. Cl. CPC G06F 3/165
USPC 715/716

(57) ABSTRACT

A method for controlling audio sessions associated with a web browser and an audio endpoint device is implemented at a computer having memory and one or more processors. The computer system provides a unified audio session channel between the web browser and the audio endpoint device, the unified audio session channel including information of an audio session manager for the audio endpoint device and a set of audio sessions that are active on the audio endpoint device. Upon receiving a user instruction for controlling audio outputs of the web browser, the computer system selects one or more audio sessions between the web browser and the audio endpoint device among the set of audio sessions that are active on the audio endpoint device. The computer system then updates the audio sessions between the web browser and the audio endpoint device according to the user instruction.

### RELATED APPLICATIONS

This application claims priority to Chinese Patent Application No. 201210060114.6, entitled “SOUND CONTROL METHOD AND DEVICE,” filed Mar. 8, 2012, which is incorporated by reference in its entirety.

### TECHNICAL FIELD

The disclosed implementations relate generally to a sound control technology implemented in a computer system, and in particular, to systems and methods for controlling sound of a web browser.

### BACKGROUND

When browsing a webpage through a web browser, a user is often bothered by sound made by the browser, e.g., an advertisement in a pop-up window, the sound effect of the webpage being visited, or the background music automatically played when the user visits a friend's homepage on a social media website. In this case, if the user mutes the sound audio player of the audio equipment attached to the computer, the local sound play is affected as well. For example, currently a user cannot listen to his/her favorite music locally while browsing the webpages with all the webpages being muted.

The conventional approach is to mute the sound of an individual web page through intercepting a sound playback process associated with the webpage. Since the sound playback in the browser is implemented using a playback plug-in, if the sound is to be muted, the plug-in needs to be found first, and a sound control operation is then performed on the plug-in. However, the sound from a web browser comes from different terminals and may be implemented through different playback software as well as playback plug-ins. To mute all the sound tracks from a web browser, the playback plug-ins need to be found one by one. On the other hand, it is common that a playback plug-in is overlooked or it is impossible for the new playback software to find the playback plug-in according to the original search method. As a result, the web browser cannot be completely muted, and some sound generated by one or more terminals may be heard from the browser.

### SUMMARY

The present invention provides a sound control method and device, to solve the problem in the prior art that the mute effect of the browser is undesirable.

To achieve the above objective, the present invention provides a sound control method, which adopts the following technical solution.

The sound control method, applied for sound control in a browser, includes: acquiring an audio session channel of a computer system, the audio session channel including the audio sessions associated with a web browser; and controlling the sound of the browser using the audio session channel.

The audio session channel is a unified channel provided by an operating system for all the sound threads. The step of controlling the sound of the browser using the audio session channel includes: enumerating an audio playback terminal to acquire an interface of the audio session channel provided by the operating system; invoking the interface to obtain all sessions of the enumerated audio playback terminal; determining whether the session is in a current process, and obtaining a determination result; and when the determination result is that the session is in the current process, invoking a mute setting tool according to an external control instruction to perform sound control on the session.

Before the step of controlling the sound of the browser through controlling the audio session channel, the control method further includes: providing a control entry for a user to input the external control instruction

The step of controlling the sound of the browser through controlling the audio session channel includes: receiving the external control instruction input by the user through the control entry, and controlling the audio session channel according to the external control instruction, so as to perform sound control on all the sound threads in the browser.

The present invention further provides a sound control device, which adopts the following technical solution.

The sound control device, applied for sound control in a browser, includes: a first acquiring module, for acquiring an audio session channel of a browser, the audio session channel being a unified channel for all sound threads in the browser; and a first control module, for controlling sound of the browser through controlling the audio session channel.

When the audio session channel is a unified channel provided by an operating system for all the sound threads, the control device includes: a second acquiring module, for enumerating an audio playback terminal to acquire an interface of the audio session channel provided by the operating system; a first invoking module, for invoking the interface to obtain all sessions of the enumerated audio playback terminal; a determining module, for determining whether the session is in a current process, and obtaining a determination result; and a second invoking module, for invoking a mute setting tool according to an external control instruction to perform sound control on the session, when the determination result is that the session is in the current process.

When the audio session channel is a unified channel provided by an audio driving layer for all the sound threads, the control module includes: a third acquiring module, for acquiring corresponding sound card equipment of the browser; and a second control module, for driving the sound card equipment according to an external control instruction to perform a sound control operation on the sound card.

The sound control device further includes: an entry module, for providing a control entry for a user to input the external control instruction.

The control module further includes: a receiving module, for receiving the external control instruction input by the user through the control entry, and controlling the audio session channel according to the external control instruction, so as to perform sound control on all the sound threads in the browser.

According to the technical solutions of the present invention, all the audio session channels of the browser are controlled through an operating system or an audio driving layer, so as to substantially eliminate the sound of the browser, thereby achieving a good mute effect and improving the user experience. In the development aspect, there is no need to search for the playback plug-ins one by one and intercept the playback process of each playback plug-in for the purpose of muting the browser, but instead, the session channel is directly intercepted or disabled through the operating system or the audio driving layer, thereby improving the development efficiency and saving the development cost.

In addition to the above descriptions, other objectives, features and advantages of the present invention will be further described in detail below with the accompanying drawings.

### BRIEF DESCRIPTION OF DRAWINGS

As a part of the application and for further understanding of the present invention, the accompanying drawings are used to explain the exemplary embodiments of the present invention, instead of limiting the present invention in an improper way, wherein:

FIG. 1 is a flow chart of the main steps in a sound control method according to some implementations of the present invention;

FIG. 2 is a flow chart of the specific steps in a sound control method according to some implementations of the present invention; and

FIG. 3 is a schematic view of the main structure of a sound control device according to some implementations of the present invention.

FIG. 4 is a block diagram of a computer system that implements the sound control method according to some implementations of the present invention.

FIGS. 5A through 5E are flow charts illustrating how the computer system controls the sound generated by a web browser according to some implementations of the present invention.

### DETAILED DESCRIPTION

Reference will now be made in detail to implementations, examples of which are illustrated in the accompanying drawings. In the following detailed description, numerous non-limiting specific details are set forth in order to assist in understanding the subject matter presented herein. It will be apparent, however, to one of ordinary skill in the art that various alternatives may be used without departing from the scope of the present invention and the subject matter may be practiced without these specific details. The embodiments of the present invention are described in detail below with reference to the accompanying drawings, but the present invention can be implemented in different manners within the appended claims.

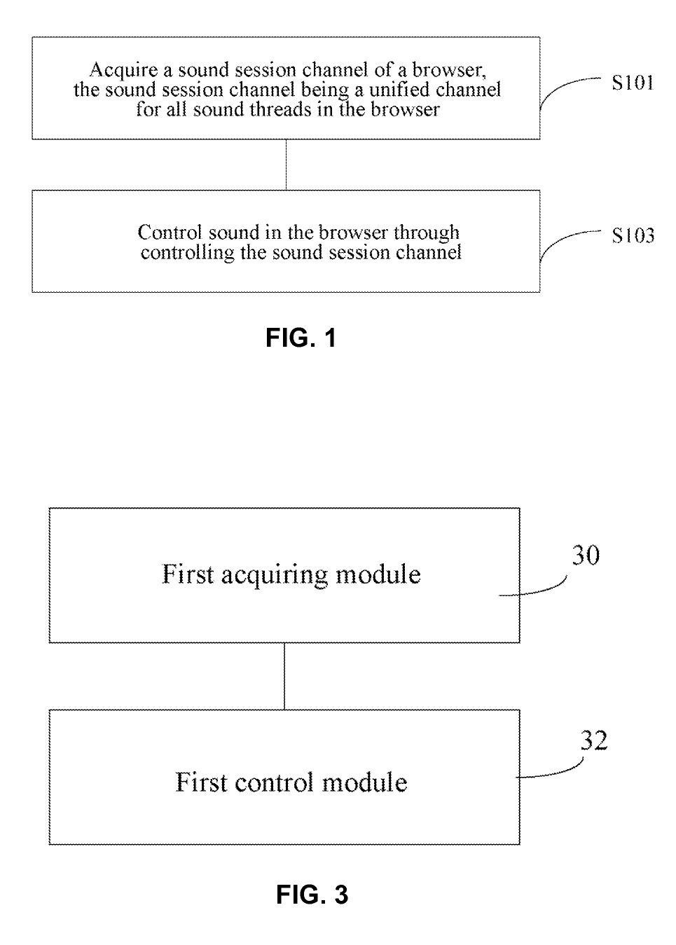

FIG. 1 is a flow chart of the main steps of a web browser sound control method according to some implementations of the present invention. Referring to FIG. 1, the sound control method includes the following steps:
S101: Acquire an audio session channel of a browser, the audio session channel being a unified channel for all the sound threads associated with the browser.
S103: Control the sound of the browser using the audio session channel.

In the present invention, the sound of the browser refers to the sound played in the browser process, including: sound played by a plug-in of the browser, or sound played by a player embedded in the browser, or background music of a webpage.

In some implementations, the step of acquiring the audio session channel of the browser in S101 refers to that, the sound of the browser comes from different audio output terminals, and each output terminal may use different sound playback software, such as Flash player, Storm player, and Real player. Each playback software has its own playback thread in operation. Traditionally, the browser is muted through controlling the playback threads. The playback threads are associated with a unified channel, which is referred to as an “audio session channel” in the present invention. Therefore, after acquiring the audio session channel, the sound of the browser is muted by intercepting or disabling the audio session channel. The step of controlling the sound of the browser using the audio session channel in S103 may be implemented in two manners, i.e., intercepting the audio session channel so that the sound passing through the audio session channel is not played, or substantially disabling the audio session channel so that the audio session channel does not work and the sound of the browser can be completely muted.

In some implementations, the audio session channel is a unified channel provided by an operating system for all the sound threads. The step of controlling the sound of the browser using the audio session channel further includes: enumerating an audio playback terminals to acquire an interface of the audio session channel provided by the operating system; invoking the interface to obtain the audio sessions of the enumerated audio playback terminal; determining whether the audio session is in a current process (i.e., associated with the browser), and if the session is in the current process, invoking a mute setting tool according to an external user control instruction to perform sound control on the audio session.

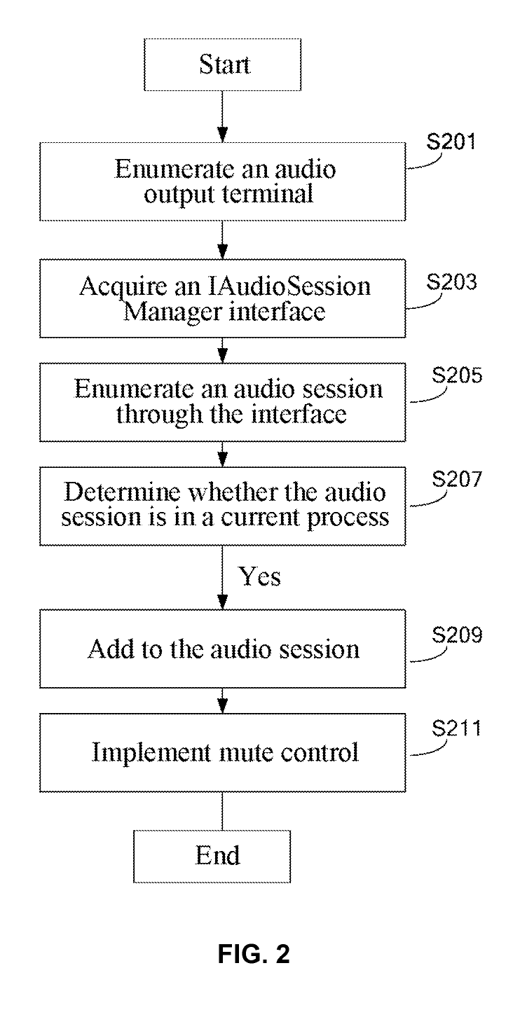

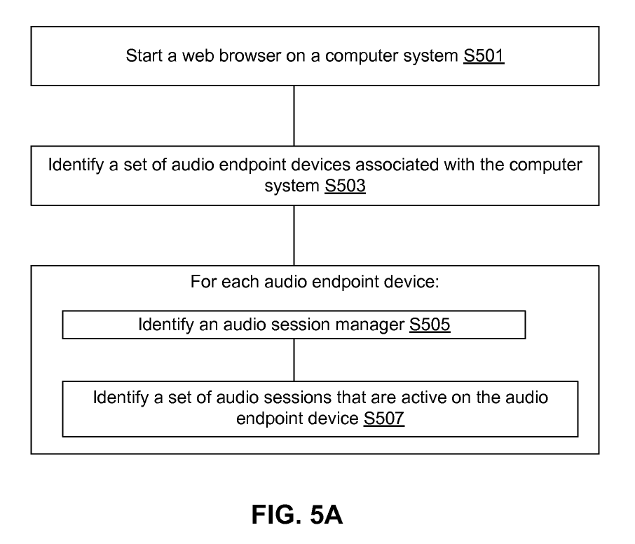

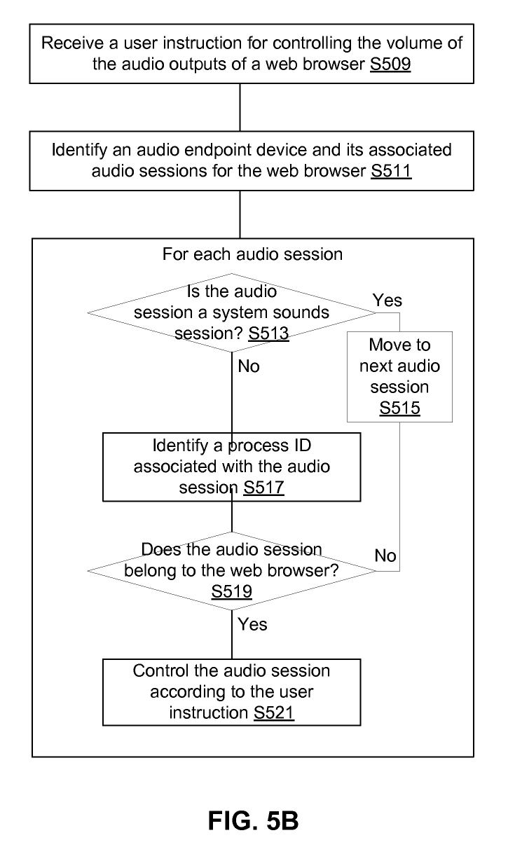

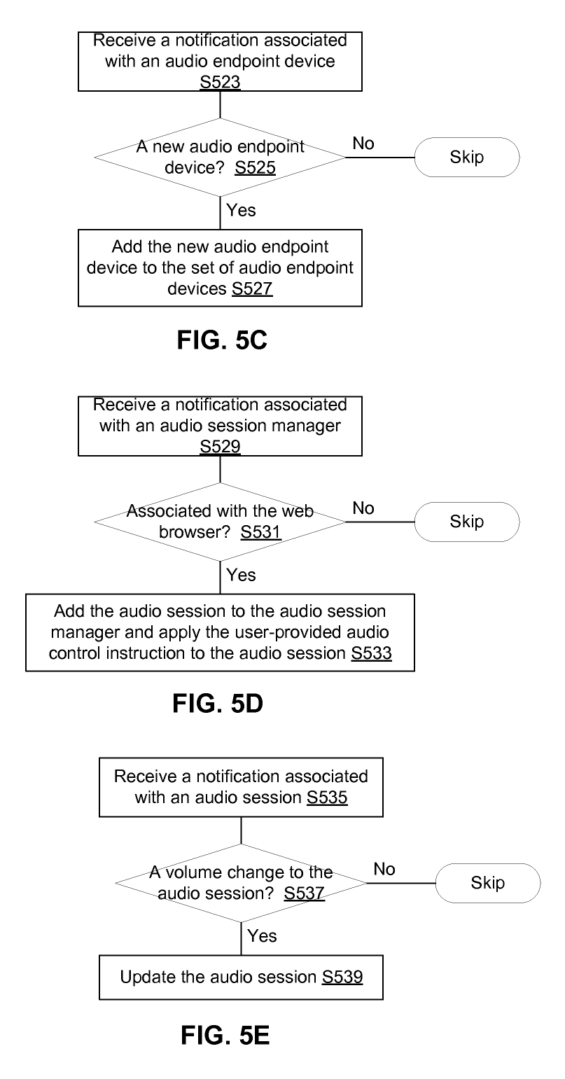

In some implementations, the audio session channel is provided by an operating system. The browser is muted through controlling the audio session channel of the operating system. A specific implementation of the present application is described below in connection with FIG. 2, which is a flow chart of the specific steps in a sound control method according to some implementations of the present invention. Referring to FIG. 2, the sound control method specifically includes the following steps.
Step S201: Enumerate audio output terminal. If the operating system is Windows by Microsoft, the audio output terminal is enumerated through an interface IMMDeviceEnumerator. The IMMDeviceEnumerator interface provides methods for enumerating multimedia device resources.
Step S203: Acquire an audio session manager interface, e.g., the IAudioSessionManager interface in Windows. The IAudioSessionManager interface is obtained through the IMMDeviceEnumerator, and it is used for setting one or more session parameters.
Step S205: Enumerate an audio session through the IAudioSessionManager interface.
Step S207: Determine whether the audio session is in a current process of the browser because the method is configured to control only the audio output from the browser. Specifically, when an application (e.g., the browser) is run, a corresponding process is generally created. At least one thread is created in the process, and a function is then invoked in the thread to implement the specific operations associated with the process. In the present application, an audio session corresponds to a process. After an audio session is acquired, it is possible to determine whether the audio session is in the current process of the browser or another process.
Step S209: If the audio session is in the current process, register a notification callback of the audio session. As will be described below in connection with FIG. 5E, the notification callback is used for updating the audio session if the audio session's volume has been update by another program other than the browser. When this happens, the browser needs to update the session parameters associated with the audio session accordingly.
Step S211: Implement the mute control to a particular audio session or sessions. For example, for the audio session of the current process of the browser, an ISimpleAudioVolume interface of the audio session is obtained by invoking an audio session control interface IAudioSessionControl. A SetMute function is invoked through the ISimpleAudioVolume interface to achieve the mute effect.

In some implementations, the audio session channel is a unified channel provided by an audio driving layer for all the sound threads in the operating system. The step of controlling the sound of the browser using the audio session channel further includes: acquiring sound card equipment of the computer system corresponding to the browser; and driving the sound card equipment according to an external user control instruction to perform a sound control operation on the sound card equipment. In some implementations, the audio session channel is provided by an audio driving layer. The browser is muted by controlling the audio session channel of the audio driving layer.

In some implementations, before the step of controlling the sound of the browser using the audio session channel, the control method further includes: providing a control entry for a user to provide the external control instruction. The step of controlling the sound of the browser using the audio session channel further includes: receiving the user-provided external user control instruction input through the control entry, and controlling the audio session channel according to the external user control instruction, so as to perform the sound control on all the sound threads associated with the browser. A control entry is provided to the user in a tag field or taskbar of the main frame of the browser. When intending to mute the browser, the user only needs to click the control entry using the mouse to provide a mute command.

FIG. 3 is a schematic view of the main structure of a sound control device according to some implementations of the present invention. Referring to FIG. 3, the sound control device includes: a first acquiring module 30, for acquiring an audio session channel of a browser, the audio session channel being a unified channel for all sound threads associated with the browser; and a first control module 32, for controlling the sound of the browser using the audio session channel.

In some implementations, the audio session channel is a unified channel provided by an operating system for all the sound threads. The control device includes: a second acquiring module (not shown), for enumerating an audio playback terminal as described above in connection with S201 to acquire an interface of the audio session channel provided by the operating system; a first invoking module (not shown), for invoking the interface to obtain all the audio sessions associated with the enumerated audio playback terminal as describe above in connection with S203 and S205; a determining module (not shown), for determining whether the session is in a current process of the browser as described above in connection with S207, and obtaining a determination result; and a second invoking module (not shown), for invoking a mute setting tool according to an external user control instruction to perform sound control on the audio session as described above in connection with S209 and S211 if the audio session is in the current process of the browser.

In some implementations, the audio session channel is a unified channel provided by an audio driving layer for all the sound threads of a computer system. The control module includes: a third acquiring module (not shown), for acquiring the sound card equipment corresponding to the browser; and a second control module (not shown), for driving the sound card equipment according to an external user control instruction to perform a sound control operation on the sound card equipment.

In some implementations, the control module further includes: an entry module (not shown), for a user to input an external user control instruction for controlling the audio output of a browser. In some implementations, the control module further includes: a receiving module (not shown), for receiving the external control instruction input by the user through the control entry, and controlling the audio session channel according to the external user control instruction, so as to perform sound control on all the sound threads associated with the browser.

According to the technical solutions of the present invention, all the audio session channels of the browser are controlled through an operating system or an audio driving layer, so as to substantially eliminate the sound of the browser, thereby achieving a good mute effect and improving the user experience. From the perspective of a developer, there is no need to search for the playback plug-ins one by one and then intercept the playback process of each playback plug-in for the purpose of muting the browser. Instead, the session channel is directly intercepted or disabled by the operating system or the audio driving layer, thereby improving the development efficiency and saving the development cost.

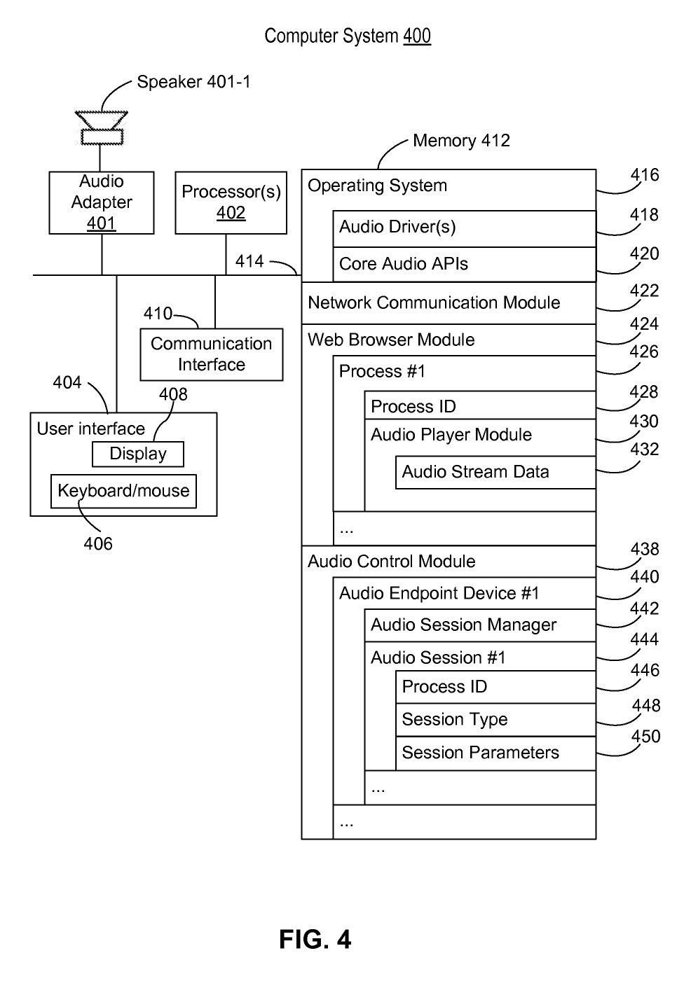

FIG. 4 is a block diagram of a computer system 400 that implements the sound control method according to some implementations of the present invention. The computer system 400 includes one or more processors 402 for executing modules, programs and/or instructions stored in memory 412 and thereby performing predefined operations; one or more network or other communications interfaces 410; memory 412; and one or more communication buses 414 for interconnecting these components. In some implementations, the computer system 400 includes a user interface 404 comprising a display device 408 and one or more input devices 406 (e.g., keyboard or mouse), and an audio adapter 401 for converting audio stream data into an audio signal to be broadcast through the speaker 401-1.

In some implementations, the memory 412 includes high-speed random access memory, such as DRAM, SRAM, DDR RAM or other random access solid state memory devices. In some implementations, memory 412 includes non-volatile memory, such as one or more magnetic disk storage devices, optical disk storage devices, flash memory devices, or other non-volatile solid state storage devices. In some implementations, memory 412 includes one or more storage devices remotely located from the processor(s) 402. Memory 412, or alternately one or more storage devices (e.g., one or more nonvolatile storage devices) within memory 412, includes a non-transitory computer readable storage medium. In some implementations, memory 412 or the computer readable storage medium of memory 412 stores the following programs, modules and data structures, or a subset thereof:
an operating system 416 that includes procedures for handling various basic system services and for performing hardware dependent tasks, including one or more audio drivers 418 for driving the audio output terminals of the computer system 400 and core audio APIs 420 for providing an interface through which applications running on the computer system (e.g., the web browser module 424) can access the resources managed by the operating system 412;
a network communications module 422 that is used for connecting the computer system 400 to other computers (e.g., a remote web server) via the communication network interfaces 410 and one or more communication networks (wired or wireless), such as the Internet, other wide area networks, local area networks, metropolitan area networks, etc.;
a web browser module 424 for a user to browse the Internet, including visiting web pages, and playing audio/video streams through the web browser module 424, the web browser module 424 further including one or more processes 426 supporting the playing of audio/video streams; in some implementations, each process includes a process ID 428 for identifying the process associated with the web browser module 424, and an audio player module 430 for playing the audio stream data 432 downloaded onto the computer system 400 from the Internet; and
an audio control module 438 for controlling all the audio output from an application (e.g., the web browser module 424), the audio control module 438 responsible for controlling one or more audio endpoint devices 440 (e.g., speaker, microphone, etc.), each audio endpoint device having an audio session manager 442 for managing one or more audio sessions 444, each audio session having an associated process ID 446, a session type 448 (e.g., system-level or application-level) and one or more session parameters 450.

As described above, an application like the web browser module 424 may provide multiple audio outputs to an audio endpoint device (e.g., the speaker 401-1) through a unified audio session channel at the operating system level. Moreover, the number of audio outputs generated by the web browser module 424 is a dynamic value that varies over time. For example, whenever a user opens a webpage that includes a video/audio stream, a new audio output associated with this webpage is added to the unified audio session channel. Therefore, it is possible to control all the audio outputs from the web browser module 424 (e.g., muting the sound) by applying a user-provided audio control instruction to the unified audio session channel. On the other hand, the unified audio session channel at the operating system level manages more than the audio outputs from a particular application or applications. A blind application of a user-provided audio control instruction may inadvertently change the audio output from an application that the user does not intend to modify. The present application is directed to an approach that applies the user-provided audio control instruction to a target application (e.g., a web browser) through the audio session channel so that the audio outputs from another application (e.g., a local music player) are not affected.

To achieve the goal of selectively controlling one or more audio outputs passing through the unified audio session channel, all the audio outputs passing through the channel should be organized so that it is possible to associate a particular audio output (also referred to as an “audio session”) with a particular application (e.g., the web browser module 424). In some implementations, an audio session is a group of related audio streams that an application can manage collectively. Applications can control the volume level and muting state of each individual session. The system applies application-specified volume and mute settings uniformly to all of the audio streams in the session. Every audio stream belongs to exactly one session. An application assigns an audio stream to a particular session at the time that it initializes the stream object. The stream retains its membership in the session for the lifetime of the stream. After a stream object is created, the object exists until an application releases the last counted reference to the object, and then the object is deleted.

FIG. 5A is a flow chart illustrating how a computer system manages the audio outputs at the unified audio session channel according to some implementations of the present invention. At step S501, the computer system starts a web browser application. The web browser application has an associated process ID, which is also used for identifying an audio session generated by the web browser.

In some implementations, the start of the web browser initiates an audio control module for managing the audio resource of the computer system. Sometimes, the audio control module is part of the web browser or a plug-in. The audio control module is responsible for managing information used for determining which audio session is associated with which application when a user decides to change the audio outputs from a particular application or applications. At S503, the audio control module identifies a set of audio endpoint devices for the computer system by invoking different interfaces or objects offered by the operating system. For example, the Windows operating system provides the IMMDeviceEnumerator::EnumAudioEndpoints method for identifying a collection of audio endpoint devices that meet specified criteria.

For each audio endpoint device, the audio control module identifies an audio session manager at S505. For example, by calling the IMMDevice::Activate method, the audio control module receives a reference to an IAudioSessionManager2 interface, which provides a family of methods for managing audio sessions associated with a particular audio endpoint device. First, by invoking the IAudioSessionManager2::GetSessionEnumerator method, the audio control module receives a pointer to the IAudioSessionEnumerator interface. By enumerating the elements in the IAudioSessionEnumerator interface, the audio control module identifies a set of audio sessions that are active on the audio endpoint device at S507. By repeating the steps S505 and S507 for each audio endpoint device, the audio control module generates a data structure like the one shown in FIG. 4 such that all the currently active audio sessions (or audio outputs) are grouped under their respective audio session managers. Moreover, each audio session has an associated process ID. As will be described below, the process ID is used for determining whether an audio session is associated with a particular application (e.g., the web browser module).

After generating the data structure for managing the audio sessions passing through the audio session channel, the audio control module is ready for controlling a particular audio session or sessions according to a specific user-provided audio control instruction. FIG. 5B is a flow chart illustrating how the computer system controls the audio outputs at the unified audio session channel in response to the user-provided audio control instruction according to some implementations of the present invention. At S509, the audio control module receives a user instruction for controlling the volume of the audio outputs of the web browser. For example, the user decides to mute all the audio sessions associated with the web browser while leaving the other audio sessions untouched, e.g., so that the user can continue browsing the Internet while listening to the music played by a local music player on the computer system.

In response to the user instruction, the audio control module identifies an audio endpoint device and its associated audio sessions in the data structure generated using the method described above in connection with FIG. 5A for the web browser at S511. For each audio session, audio control module receives a reference to the audio session's control interface. For example, the IAudioSessionControl interface in the Windows operating system enables a client (e.g., the audio control module) to configure the control parameters for an audio session and to monitor events in the session. As noted above, the audio control module needs to apply the user instruction to the audio sessions from the web browser. On the other hand, it is possible that the audio sessions corresponding to the same audio endpoint device may come from different sources, some of which are at the system level and some of which are at the application level. For example, when a computer powers on, there a system-level beep sound and this sound should not be affected by the user instruction.

As shown in FIG. 5B, the audio control module first eliminates the audio sessions associated with the operating system at S513. To do so, the audio control module checks the process ID of a particular audio session. If the process ID indicates that the audio session is a system sounds session (S513—Yes), the audio control module then moves to examine the next audio session associated with the audio endpoint device at 5515. For example, the IAudioSessionControl2 interface in the Windows operating system can be used by a client to get information about an audio session. In particular, the IsSystemSoundsSession method of the IAudioSessionControl2 interface returns a value indicating whether the audio session is a system sounds session or not.

Besides the system sounds session, an audio session may be associated with an application other than the application (e.g., the web browser) that the user wants to control. To avoid changing the audio sessions associated with other application, the audio control module has to further eliminate these audio sessions from consideration. As shown in FIG. 5B, after the audio session being examined is determined to be not a system sounds audio session (S513—No), the audio control module then identifies a process associated with the audio session at S517 using, e.g., the IAudioSessionControl2::GetProcessld method in the Windows operating system. Next, the audio control module compares the process ID associated with the audio session with a process ID associated with the web browser. If the two process IDs do not match (S519—No), the audio control module then moves to process the next audio session at S515. Otherwise (S519—Yes), the audio control module then applies the user-provided audio control instruction to the audio session at S521.

Note that the user-provided audio control instruction may one of the group consisting of muting an audio session, unmuting an audio session, and increasing/decreasing the volume of an audio session. One skilled in the art would understand that the audio control module repeats the steps S513 to S521 for every audio session associated with the audio endpoint device. In some implementations, an application may have audio sessions associated with multiple audio endpoint devices. In this case, the audio control module may perform the same procedure shown in FIG. 5B to every device so as not to miss an audio session. This feature is useful because, when a user provides an application-level instruction, he/she expects that the application (e.g., the browser) is going to abide by the user instruction until there are some new changes to the computer system initiated by the user. In other words, the audio control module is not only responsible for applying the user instruction to the audio sessions currently active on the computer system but also adapted to accommodate future changes to the target application (e.g., the web browser) that the audio control module is to manage.

FIGS. 5C through 5E are three flow charts illustrating how the computer system handles three scenarios of changes to the unified audio session channel according to some implementations of the present invention. In some implementations, a new audio endpoint device may be coupled to the computer system after the audio control module applies the user audio control instruction to an application, e.g., muting all the audio sessions associated with a particular audio endpoint device. As a result, the data structure associated with the audio control module shown in FIG. 4 needs to be updated to include the newly added audio endpoint device. For example, the audio control module registers itself with the operating system using the IMMDeviceEnumerator::RegisterEndpointNotificationCallback method. When the operating system identifies a new audio endpoint device, it sends a notification to the audio control module at S523. The audio control module then checks whether it has an entry for the new audio endpoint device at S525. If not (S525—Yes), the audio control module adds the new audio endpoint device to the list at S527.

In some implementations, a user may open a new webpage that plays an audio stream after the audio control module applies the user audio control instruction to an application, e.g., muting all the audio sessions associated with a particular audio endpoint device. To avoid playing the audio stream, the audio control module pre-registers itself with the operating system using the IAudioSessionManager2::RegisterSessionNotification method so that it can receive a system notification when a new audio session is created. Upon receiving the system notification of a new audio session at S529, the audio control module first determines whether the audio session is associated with the target application (e.g., the web browser) at S531. If true (S531—Yes), the audio control module then adds the audio session to a corresponding audio session manager based on the association between the web browser and the audio endpoint device and then applies the user-provided audio control instruction to this new audio session at S533. In other words, the user only needs to provide an audio control instruction once to the audio control module without being bothered by future audio outputs when he/she starts another audio session when visiting another webpage.

As noted above, there are different ways of controlling the audio outputs from a computer system, some of which at the system level and some of which at the application level. It is often the case that the user prefer that the system-level adjustment overwrites the application-level adjustment. For example, when a user can change the volume of the audio outputs through the sound icon in the control panel of the operating system, it should affect all the audio sessions in the unified audio session channel. If there was a user audio control instruction applied to a particular application, e.g., muting the audio sessions from the web browser, the system-level adjustment should unmute them. In this case, the audio control module should adjust its own settings in order to be consistent with the system-level adjustment. In some implementations, the audio control module registers itself with the system using the IAudioSessionControl::RegisterAudioSessionNotification method. After receiving a system notification associated with the audio session at S535, the audio control module determines whether there is a volume change to the audio session by the operating system at S537. If so (S537—Yes), the audio control module then updates the audio session accordingly at S539. For example, if the audio session was muted before, the audio control module unmutes the audio session and sets the volume of the audio session according to the system notification. In some implementations, the audio control module also displays a message on the display of the computer system, indicating the update to the application associated with the audio session if this update is different from the user audio control instruction provided previously.

Reference has been made in detail to implementations, examples of which are illustrated in the accompanying drawings. While particular implementations are described, it will be understood it is not intended to limit the invention to these particular implementations. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the implementations.

Although the terms first, second, etc. may be used herein to describe various elements, these elements should not be limited by these terms. These terms are only used to distinguish one element from another. For example, first ranking criteria could be termed second ranking criteria, and, similarly, second ranking criteria could be termed first ranking criteria, without departing from the scope of the present invention. First ranking criteria and second ranking criteria are both ranking criteria, but they are not the same ranking criteria.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive set of alternatives. Moreover, it should be recognized that the stages could be implemented in hardware, firmware, software or any combination thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain principles of the invention and its practical applications, to thereby enable others skilled in the art to best utilize the invention and various implementations with various modifications as are suited to the particular use contemplated. Implementations include alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the implementations.

What is claimed is:

1. A method for controlling audio sessions associated with a web browser and an audio endpoint device, the method comprising:
at a computer having memory and one or more processors:
providing a unified audio session channel between the web browser and the audio endpoint device, the unified audio session channel including information of an audio session manager for the audio endpoint device and a set of audio sessions that are active on the audio endpoint device;
receiving a user instruction for controlling audio outputs of the web browser;
in response to the user instruction:
selecting one or more audio sessions between the web browser and the audio endpoint device among the set of audio sessions that are active on the audio endpoint device; and
updating the one or more audio sessions between the web browser and the audio endpoint device according to the user instruction.

2. The method of claim 1, wherein selecting one or more audio sessions between the web browser and the audio endpoint device further includes:
determining a process identifier for the web browser;
for each of the set of audio sessions that are active on the audio endpoint device:
checking whether the audio session is a system sounds session or not;
identifying a process identifier for the audio session if it is not a system sounds session;
comparing whether the process identifier of the audio session matches the process identifier of the web browser; and
identifying the audio session as an audio between the web browser and the audio endpoint device if the two process identifiers match each other.

3. The method of claim 1, wherein updating the one or more audio sessions between the web browser and the audio endpoint device according to the user instruction further includes:
for each of the one or more audio sessions between the web browser and the audio endpoint device:
determining a current volume level of the audio session;
comparing the current volume level with a user-specified volume level in the user instruction; and
changing the current volume level to the user-specified volume level if the two levels do not match each other.

4. The method of claim 1, wherein the user instruction is one selected from the group consisting of muting the audio sessions between the web browser and the audio endpoint device, unmuting the audio sessions between the web browser and the audio endpoint device, increasing volumes of the audio sessions between the web browser and the audio endpoint device, and decreasing volumes of the audio sessions between the web browser and the audio endpoint device.

5. The method of claim 1, further comprising:
after updating the one or more audio sessions between the web browser and the audio endpoint device according to the user instruction:
receiving a notification of a new audio session between the web browser and the audio endpoint device;
in response to the notification:
adding the new audio session to the unified audio session channel; and
applying the user instruction to the new audio session.

6. The method of claim 1, further comprising:
after updating the one or more audio sessions between the web browser and the audio endpoint device according to the user instruction:
receiving a notification of a system-level update to an audio session associated with the audio endpoint device;
in response to the notification:
updating the one or more audio sessions between the web browser and the audio endpoint device in accordance with the system-level update; and
displaying a message indicating of the system-level update to the one or more audio sessions between the web browser and the audio endpoint device.

7. The method of claim 1, wherein audio sessions active on the audio endpoint device are associated with at least two different applications and the updating of the one or more audio sessions between the web browser and the audio endpoint device according to the user instruction does not affect the audio sessions not associated with the web browser.

8. The method of claim 7, wherein the audio sessions not associated with the web browser includes an audio session between a music player application running on the computer system and the audio endpoint device.

9. A computer system for controlling audio sessions associated with a web browser and an audio endpoint device, the computer system comprising:
one or more processors; and
memory for storing one or more programs, wherein the one or more programs, when executed by the one or more processors, cause the computer system to perform the following instructions:
providing a unified audio session channel between the web browser and the audio endpoint device, the unified audio session channel including information of an audio session manager for the audio endpoint device and a set of audio sessions that are active on the audio endpoint device;
receiving a user instruction for controlling audio outputs of the web browser;
in response to the user instruction:
selecting one or more audio sessions between the web browser and the audio endpoint device among the set of audio sessions that are active on the audio endpoint device; and
updating the one or more audio sessions between the web browser and the audio endpoint device according to the user instruction.

10. The computer system of claim 9, wherein the instruction for selecting one or more audio sessions between the web browser and the audio endpoint device further includes instructions for:
determining a process identifier for the web browser;
for each of the set of audio sessions that are active on the audio endpoint device:
checking whether the audio session is a system sounds session or not;
identifying a process identifier for the audio session if it is not a system sounds session;
comparing whether the process identifier of the audio session matches the process identifier of the web browser; and
identifying the audio session as an audio between the web browser and the audio endpoint device if the two process identifiers match each other.

11. The computer system of claim 9, wherein the instruction for updating the one or more audio sessions between the web browser and the audio endpoint device according to the user instruction further includes instructions for:
for each of the one or more audio sessions between the web browser and the audio endpoint device:
determining a current volume level of the audio session;
comparing the current volume level with a user-specified volume level in the user instruction; and
changing the current volume level to the user-specified volume level if the two levels do not match each other.

12. The computer system of claim 9, wherein the user instruction is one selected from the group consisting of muting the audio sessions between the web browser and the audio endpoint device, unmuting the audio sessions between the web browser and the audio endpoint device, increasing volumes of the audio sessions between the web browser and the audio endpoint device, and decreasing volumes of the audio sessions between the web browser and the audio endpoint device.

13. The computer system of claim 9, further comprising instructions for:
after updating the one or more audio sessions between the web browser and the audio endpoint device according to the user instruction:
receiving a notification of a new audio session between the web browser and the audio endpoint device;
in response to the notification:
adding the new audio session to the unified audio session channel; and
applying the user instruction to the new audio session.

14. The computer system of claim 9, further comprising instructions for:
after updating the one or more audio sessions between the web browser and the audio endpoint device according to the user instruction:
receiving a notification of a system-level update to an audio session associated with the audio endpoint device;
in response to the notification:
updating the one or more audio sessions between the web browser and the audio endpoint device in accordance with the system-level update; and
displaying a message indicating of the system-level update to the one or more audio sessions between the web browser and the audio endpoint device.

15. The computer system of claim 9, wherein audio sessions active on the audio endpoint device are associated with at least two different applications and the updating of the one or more audio sessions between the web browser and the audio endpoint device according to the user instruction does not affect the audio sessions not associated with the web browser.

16. A non-transitory computer readable medium used in conjunction with a computer system for controlling audio sessions associated with a web browser and an audio endpoint device, the computer readable medium comprising instructions for:
providing a unified audio session channel between the web browser and the audio endpoint device, the unified audio session channel including information of an audio session manager for the audio endpoint device and a set of audio sessions that are active on the audio endpoint device;
receiving a user instruction for controlling audio outputs of the web browser;
in response to the user instruction:
selecting one or more audio sessions between the web browser and the audio endpoint device among the set of audio sessions that are active on the audio endpoint device; and
updating the one or more audio sessions between the web browser and the audio endpoint device according to the user instruction.

17. The non-transitory computer readable medium of claim 16, wherein the instruction for selecting one or more audio sessions between the web browser and the audio endpoint device further includes instructions for:
determining a process identifier for the web browser;
for each of the set of audio sessions that are active on the audio endpoint device:
checking whether the audio session is a system sounds session or not;
identifying a process identifier for the audio session if it is not a system sounds session;
comparing whether the process identifier of the audio session matches the process identifier of the web browser; and
identifying the audio session as an audio between the web browser and the audio endpoint device if the two process identifiers match each other.

18. The non-transitory computer readable medium of claim 16, wherein the instruction for updating the one or more audio sessions between the web browser and the audio endpoint device according to the user instruction further includes instructions for:
for each of the one or more audio sessions between the web browser and the audio endpoint device:
determining a current volume level of the audio session;
comparing the current volume level with a user-specified volume level in the user instruction; and
changing the current volume level to the user-specified volume level if the two levels do not match each other.

19. The non-transitory computer readable medium of claim 16, wherein the user instruction is one selected from the group consisting of muting the audio sessions between the web browser and the audio endpoint device, unmuting the audio sessions between the web browser and the audio endpoint device, increasing volumes of the audio sessions between the web browser and the audio endpoint device, and decreasing volumes of the audio sessions between the web browser and the audio endpoint device.

20. The non-transitory computer readable medium of claim 16, further comprising instructions for:
after updating the one or more audio sessions between the web browser and the audio endpoint device according to the user instruction:
receiving a notification of a new audio session between the web browser and the audio endpoint device;
in response to the notification:
adding the new audio session to the unified audio session channel; and
applying the user instruction to the new audio session.
